(19) United States
(12) Patent Application Publication
(10) Pub. No.: US 2014/0247194 A1
(43) Pub. Date: Sep. 4, 2014

(54) GNSS ANTENNAS

(71) Applicant: Hemisphere GNSS Inc., Scottsdale, AZ (US)

(72) Inventors: Gregory J. Durnan, Tempe, AZ (US); Walter J. Feller, Airdrie (CA)

(73) Assignee: Hemisphere GNSS Inc., Scottsdale, AZ (US)

(21) Appl. No.: 14/069,223

(22) Filed: Oct. 31, 2013

Related U.S. Application Data
(60) Provisional application No. 61/720,915, filed on Oct. 31, 2012.
(60) Provisional application No. 61/720,891, filed on Oct. 31, 2012.
(60) Provisional application No. 61/720,905, filed on Oct. 31, 2012.
(60) Provisional application No. 61/732,787, filed on Dec. 3, 2012.

(51) Int. Cl. H01Q 7/00; H01Q 9/04

(52) U.S. Cl. CPC H01Q 7/00; H01Q 9/0407
USPC 343/867; 343/700 MS

(57) ABSTRACT

A global navigation satellite system (GNSS) antenna system includes interference mitigation and multipath canceling. Multiple ports or phased arrays of antennas can be provided. Antennas can comprise controlled radiation pattern antennas (CRPA). Crossed dipole and patch antenna configurations can be utilized.

### CROSS-REFERENCE TO RELATED APPLICATIONS AND PATENT

This application is related to and claims priority in U.S. patent application Ser. No. 61/720,915, filed Oct. 31, 2012; Ser. No. 61/720,891, filed Oct. 31, 2012; Ser. No. 61/720,905, filed Oct. 31, 2012; and Ser. No. 61/732,787, filed Dec. 3, 2012, all of which are incorporated herein by reference. U.S. Pat. No. 8,102,325 is also incorporated herein by reference.

### BACKGROUND OF THE INVENTION

1. Field of the Invention

The present invention relates generally to antennas, and in particular, to broadband antennas which are particularly well-suited for GNSS applications and which include antenna components formed of polytetrafluoroethelyne (PTFE) materials.

2. Description of the Related Art

Various antenna designs and configurations have been produced for transmitting and receiving electromagnetic (wireless) signals. Antenna design criteria include the signal characteristics and the applications of the associated equipment, i.e., transmitters and receivers. For example, stationary, fixed applications involve different antenna design configurations from mobile equipment.

Global navigation satellite systems (GNSS) have progressed within the last few decades to their present state-of-the-art, which accommodates a wide range of positioning, navigating, and informational functions and activities. GNSS applications are found in many industries and fields of activity. For example, navigational and guidance applications involve portable GNSS receivers ranging from relatively simple, consumer-oriented, handheld units to highly sophisticated airborne and marine vessel equipment.

Vehicle-mounted antennas are designed to accommodate vehicle motion, which can include movement in six degrees of freedom, i.e., pitch, roll and yaw corresponding to vehicle rotation about X, Y and Z axes in positive and negative directions respectively, as well as translations along such axes. Moreover, variable and dynamic vehicle attitudes and orientations necessitate antenna gain patterns which provide GNSS ranging signal strengths throughout three-dimensional ranges of motion corresponding to the vehicles' operating environments, for example, aircraft in banking maneuvers that the require below-horizon signal reception. Ships and other large marine vessels, on the other hand, tend to operate relatively level and therefore normally do not require below-horizon signal acquisition. Terrestrial vehicles have varying optimum antenna gain patterns dependent upon their operating conditions. Agricultural vehicles and equipment, for example, often require signal reception in various attitudes in order to accommodate operations over uneven terrain. Modern precision agricultural GNSS guidance equipment, e.g., sub-centimeter accuracy, requires highly efficient antennas which are adaptable to a variety of conditions.

Another antenna/receiver design consideration in the GNSS field relates to multipath interference, which is caused by reflected signals that arrive at the antenna out of phase with the direct signal. Multipath interference is most pronounced at low elevation angles of reception, e.g., from about 10 to 20 degrees above the horizon. They are typically reflected from the ground and ground-based objects. Antennas with strong gain patterns at or near the horizon are particularly susceptible to multipath signals, which can significantly interfere with receiver performance based on direct line-of-sight (LOS) reception of satellite ranging signals and differential correction signals (e.g., DGPS). Therefore, important GNSS antenna design objectives include achieving the optimum gain pattern, balancing rejecting multipath signals, and receiving desired ranging signals from sources, e.g., satellites and pseudolites, at or near the horizon.

Because it is desirable to improve the accuracy, reliability, and confidence level of an attitude or position determined through use of a GNSS, a Satellite-Based Augmentation System (SBAS) may be incorporated if one that is suitable is available. There are several public SBASs that work with GPS. These include the Wide Area Augmentation System (WAAS), developed by the United States Federal Aviation Authority, European Geostationary Navigation Overlay Service (EGNOS), developed by the European Community, as well as other public and private pay-for-service systems such as OmniSTAR®.

Conventional GPS antennas include ceramic patch, cross dipole, and microstrip patch configurations. Ceramic patch designs are of compact size and have the benefit of low cost, but their bandwidths tend to be narrow and they are not generally suitable in high accuracy applications. The cross dipole antenna has a high gain at low elevation angles and consequently exhibits less desirable multipath performance. It also has complicated assembly issues. There are numerous microstrip patch antennas in the art including commonly assigned U.S. Pat. No. 5,200,756 issued to Feller. This three dimensional microstrip patch antenna has relatively high gain at low elevation angles. U.S. Pat. No. 6,252,553, issued to Solomon, is a multi-mode patch antenna system and method of forming and steering a spatial null. This antenna uses four feed probes and geometrical non-symmetry, and the radiating patch is assembled over the ground plane. The active circuit employed also requires an additional circuit card. U.S. Pat. No. 6,445,354, issued to Kunysz, is termed a pinwheel antenna design. The pinwheel antenna has generally good performance including the ability to reduce multipath interference, but it is difficult to manufacture compared to other antenna configurations. This antenna also employs two circuit cards, an RF absorber, and a cable connection between both cards. U.S. Pat. No. 6,597,316, issued to Rao et al., is a spatial null steering microstrip antenna array. This antenna also exhibits good multipath reducing properties and accuracy but its feed circuit is comparatively complicated, consisting of four coaxial probes and three combiners. U.S. Pat. Nos. 5,200,756; 6,252,553; 6,445,354; and 6,597,316 are incorporated herein by reference.

Conventional patch antennas are typically formed of a patch radiation element positioned in relation to a ground plane, and electrically referenced thereto, and separated from the ground plane by a dielectric material. The dielectric material most commonly used is an FR-4 composite which is a common printed circuit board (PCB) material formed of glass fiber reinforced epoxy resin. Commonly assigned U.S. Pat. No. 7,429,952, issued to Sun and incorporated herein by reference, is directed to a patch antenna configuration including a patch radiation element formed on an upper PC board and a ground plane PCB separated from the patch board by dielectric layers formed of a ceramic/PTFE composite. There are problems with the use of composite materials as dielectrics including indeterminate homogeneity and consistency. Material inconsistencies which would not be a problem at HF or VHF frequencies become a concern at L-Band and higher frequencies because of the proportionately shorter wavelengths involved at such frequencies. Additionally, the relatively high dielectric constant of materials like FR-4 is a factor in the narrow bandwidth of patch antennas formed therefrom, and a narrow bandwidth is desirable in some applications for reducing interference with desired signals. In some GNSS applications, an increased bandwidth is desirable to receive various GNSS ranging signals and additionally SBAS augmentation signals.

### SUMMARY OF THE INVENTION

The present invention is directed to GNSS antenna configurations including a radiating structure positioned in spaced relation to a ground plane with one or more intervening dielectric layers formed of polytetrafluoroethelyne (PTFE) materials. The use of PTFE materials in the dielectric layer results in lower loss compared to FR-4 composites and other materials and moderate bandwidth in the antenna unit to accommodate multiple GNSS frequencies and augmentation signals.

An embodiment of the GNSS antenna is a patch antenna configuration including a circular upper patch antenna PC board, a circular PTFE dielectric layer, and a circular ground plan PC board with a low noise amplifier (LNA) and other components fabricated thereon. The patch antenna board may be a copper clad FR-4 board etched to form a circular patch antenna radiator on a top surface. The antenna board is preferably of a very thin dimension to minimize signal losses. In an embodiment of the patch antenna board, the radiator element and the supporting board are drilled to form a cross-pattern of four lines of holes radiating at 90° intervals from a center point. The dielectric layer can be formed by one or more circular sheets of PTFE to achieve a desired thickness. The PTFE dielectric boards are provided with a pair of crossed slots which intersect at the center of the sheets. The ground plane board can be formed by a circular FR-4 board which is foil clad to form a ground plane for the antenna unit. The ground plane cladding can be formed on the upper side of the ground plane board with microstrip conductors on the lower surface to form or connect circuit elements of the LNA and a four port hybrid combiner. Alternatively, it is foreseen that the ground plane cladding may be formed on the lower surface of the ground plane board with etched openings receiving the elements of the LNA and the hybrid.

The antenna patch board, the dielectric boards, and the ground plane board are provided with aligned holes to receive fasteners, such as nylon screws and nuts. The boards are assembled with the crossed slots in the dielectric boards aligned with the lines of holes in the antenna patch board. Selected feed holes of the lines of holes are aligned with port terminals of the hybrid. Tinned copper conductors are soldered between the feed holes and the port terminals of the hybrid and extend through the slots in the dielectric boards to form feed lines to the hybrid. The patch antenna unit may be housed in an enclosure including a base support and a top cover or radome to seal the antenna unit therein. The enclosure may include one or more external line feeds for connection to GNSS processing circuitry, such as a GNSS receiver and circuitry controlling displays, controlled equipment, or the like. The enclosure may also include mounting hardware for mounting the antenna unit, as on the roof of a vehicle.

The GNSS antenna system of the present invention, using a PTFE dielectric layer above a ground plane, can also be applied to antenna radiator configurations other than the circular patch configuration described above. The antenna configurations can include a dual frequency circular patch configuration with a capacitor-tuned etched slot, a crossed dipole configuration with dipole arms supported by a mast or vertical member, a low profile crossed dipole configuration with dipole arms formed by etching a PC board which is shaped to a desired profile, and the like. In each configuration, the radiating element or structure is spatially and electrically referenced to a ground plane through a dielectric layer formed by one or more layers of PTFE material.

The present invention is directed to GNSS antenna configurations including a crossed loop GNSS antenna system with loop conductors formed on printed circuit boards (PCBs) with a substrate formed of polytetrafluoroethelyne (PTFE) materials. A radiating assembly of the antenna is formed of a pair of the circuit boards which are joined in an intersecting manner to position two loop antenna components in a 90° angular relationship. Each of the loop boards includes a rectangular section, with a pair of outer support legs depending therefrom. In an embodiment of the crossed loop antenna system, the loop boards are sized to accommodate a full wave sized square loop antenna element at the desired operating frequency. Thus, each side of the loop is approximately a quarter wavelength long.

One of the loop boards is a top slotted loop board and has a top slot formed therein which extends from a center of the rectangular section to the top edge of the top slotted loop board. The other loop board is a bottom slotted loop board and has a bottom slot extending from the center of the rectangular section to the bottom edge of the bottom slotted loop board. The loop boards are joined in an intersecting relationship by aligning the top slot with the bottom slot and sliding the boards along the slots until the center ends of the slots meet. In some embodiments of the crossed loop antenna system, edges of the slots may be secured to the other loop board by the use of an adhesive, glue, cement, welding, or the like. Lower ends of the support legs may be provided with mounting tabs which may be provided with tab solder pads, as will be described further below.

The loop boards are formed of foil covered PC boards of which a substrate is a polytetrafluoroethelyne or PTFE material. The foil is etched away to leave the loop conductors of the boards. On the top slotted loop board, there is a gap in a top conductor section where the top conductor intersects the top slot. The separated ends of the top conductor are provided with gap solder pads. The center of the top conductor of the bottom slotted loop board is provided with an elongated solder pad on both sides which are interconnected, as by a plated-through hole. Ends of the elongated solder pads are soldered to the gap solder pads when the loop boards are joined to bridge the top conductor gap of the top slotted loop board. Bottom ends of the loop conductor of each loop board are provided with feed terminal solder pads at the bottom edges of the square section of the loop boards. Although the loop boards described above are of a single layer of substrate, it is foreseen that the loop boards could be formed as two layer laminates with the loop conductors sandwiched between the substrates of the laminate.

An embodiment of the crossed loop antenna system includes a ground plane board on which the intersected loop boards are mounted. The ground plane board may be of a conventional PC board configuration, such as of a foil cladded FR-4 construction. Preferably, foil cladding an upper surface of the ground plane board is substantially complete, except in areas through which conductors are required to pass. The ground plane board is provided with loop board mounting slots which receive the tabs at the ends of the support legs. The tabs may be secured to the ground plane board by soldering the tab solder pads to the foil cladding on the top surface, and possibly the lower surface, of the ground plane board. On the lower side of the ground plane board, low noise amplifier or LNA circuitry may be provided. Preferably, a separate LNA board is provided which has components of the LNA circuitry positioned on a bottom surface. The LNA board can be separated from the ground plane board by one or more layers, such as layers of PTFE or other dielectric material. The LNA circuitry may be formed by a combination of surface mount elements and microstrip components etched from foil cladding on the lower surface of the LNA board.

In an embodiment of the crossed loop antenna system, the loop conductors are connected to a combiner board positioned at the lower edges of the rectangular sections of the loop boards. The combiner board may be of a generally square shape and has conductors thereon which form a hybrid combiner to receive signals from the loop conductors in the proper phases. The combiner may be connected to the LNA circuitry by means of a short section of coaxial cable. The combiner board may be supported by non-conductive stand-off legs and non-conductive screws.

The crossed loop antenna unit may be housed in an enclosure including a base support and a top cover or radome to seal the antenna unit therein. The enclosure may include one or more external antenna line feeds for connection to GNSS processing circuitry, such as a GNSS receiver and circuitry controlling displays, controlled equipment, or the like. The enclosure may also include mounting hardware for mounting the antenna unit, as on the roof of a vehicle.

Various objects and advantages of the present invention will become apparent from the following description taken in conjunction with the accompanying drawings wherein are set forth, by way of illustration and example, certain embodiments of this invention.

Various objects and advantages of the present invention will become apparent from the following description taken in conjunction with the accompanying drawings wherein are set forth, by way of illustration and example, certain embodiments of this invention.

### BRIEF DESCRIPTION OF THE DRAWINGS

The drawings constitute a part of this specification, include exemplary embodiments of the present invention, and illustrate various objects and features thereof.

FIG. 1 is a schematic diagram of a typical high precision GPS (GNSS) arrangement.

FIG. 2 is a schematic diagram of another typical arrangement.

FIG. 3 is a schematic diagram of an arrangement with low noise amplifiers (LNAs) connected to antennas or ports.

FIG. 4 is a schematic diagram of a general arrangement for a simplified narrow bandwidth (CW) controlled radiation pattern antenna (CRPA).

FIG. 5 is a schematic diagram of a general arrangement for a phased array with four antennas or ports.

FIG. 6 shows a phased antenna array with ceramic patch antennas.

FIG. 7 is an enlarged, side elevational view of an embodiment of an antenna system with PTFE components according to the present invention in the form of a patch type antenna unit, with a part shown in cross section to illustrate components of the antenna unit.

FIG. 8 is an exploded perspective view of the components of the patch type antenna unit.

FIG. 9 is a top plan view of a patch antenna assembly of the patch type antenna unit.

FIG. 10 is a top plan view of a pair of PTFE layers of the antenna unit.

FIG. 11 is a bottom plan view of a low noise amplifier (LNA) assembly mounted on a lower side of a ground plane board of the patch type antenna unit.

FIG. 12 is an enlarged, side elevational view of a modified embodiment of an antenna system with a total of four PTFE layers, with a part shown in cross section to illustrate components of the antenna unit.

FIG. 13 is an enlarged perspective view of a modified patch embodiment of a dual frequency antenna unit of the present invention which incorporates an etched slot element tuned to a second frequency.

FIG. 13A is an enlarged detail of the antenna unit embodiment shown in FIG. 13 with a single-capacitor patch tuning point.

FIG. 13B is an enlarged detail of the antenna unit embodiment shown in FIG. 13 with a double-capacitor patch tuning point.

FIG. 14 is a perspective view of a radiating element of a low profile crossed dipole antenna unit according to the present invention.

FIG. 15 is a cross sectional view of the low profile crossed dipole antenna taken on line 9-9 of FIG. 14 and illustrating further details thereof.

FIG. 16 is an enlarged perspective view of a vertically extended crossed dipole antenna unit according to the present invention.

FIG. 17 is a side elevational view of an embodiment of a crossed loop antenna system of the present invention with portions broken away to illustrate components thereof.

FIG. 18 is a perspective view of the crossed loop antenna system with a radome removed to illustrate loop antenna boards of the system.

FIG. 19 is a top plan view of a ground plane board of the crossed loop antenna system.

FIG. 20 is a bottom plan view of an LNA board of the crossed loop antenna system with LNA circuitry mounted on the lower side thereof.

FIG. 21 is an elevational view of the loop antenna boards being fitted together in a crossing configuration.

### DETAILED DESCRIPTION OF THE PREFERRED EMBODIMENTS

### I. Introduction and Environment

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning

### II. Automatic Signal Maximization for GPS Antennas

In typical high precision GPS antenna systems (e.g., FIG. 1) one of the principal methods of ensuring high quality RHCP polarization is to utilize a passive phasing network or hybrid component. This is essential in environments with high levels of multipath interference. Difficulty can arise in multiband antennas due to signal loss in this device, which may be exasperated by use of additional front end filtering. In addition passive devices are only available for some ports numbering (i.e., a 2 port hybrid or a 4 port combiner).

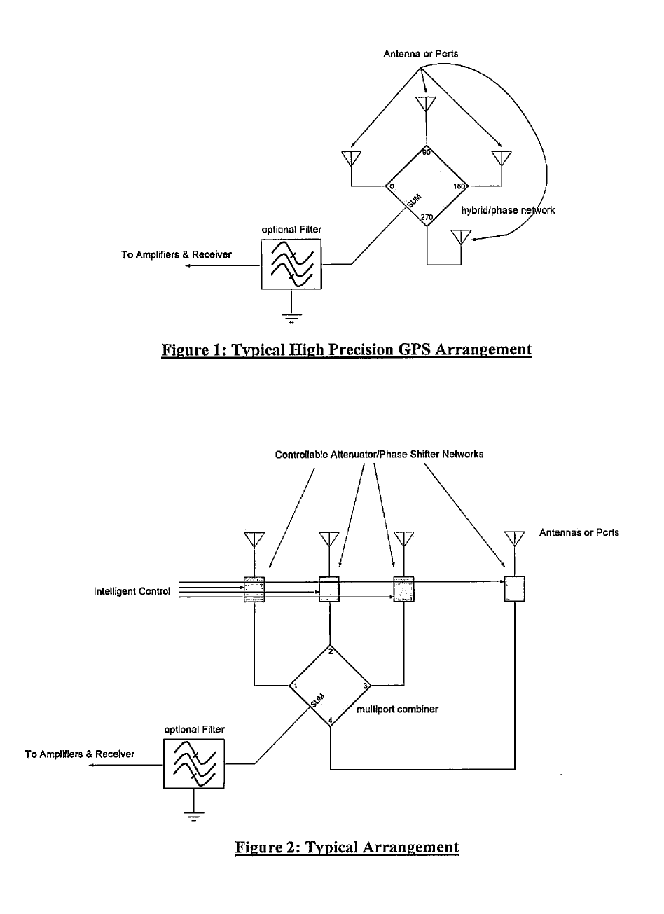

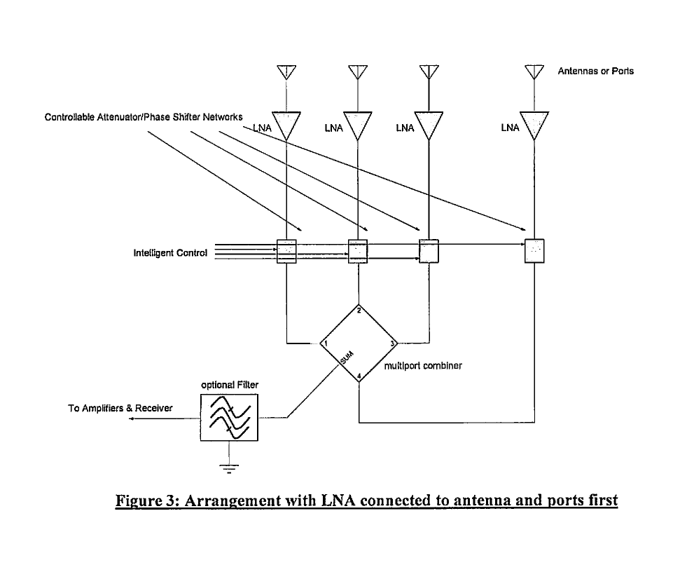

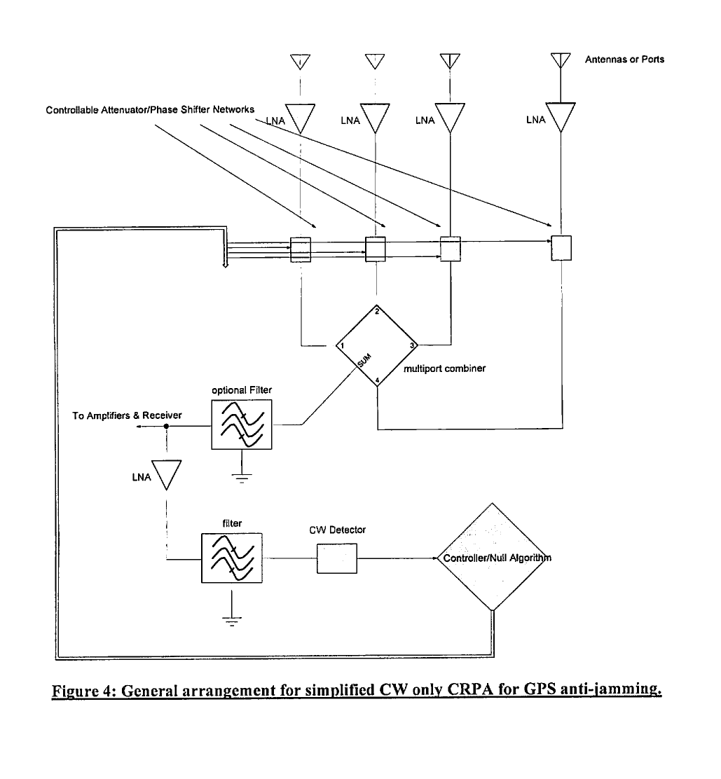

As a universal alternative for that arrangement this application proposes that an analog or digital control network may be fitted as a replacement. This control network may consist of a a) Phase Shifter and/or b) Attenuator. The advantage of this arrangement is that these phase shifters may not need to be connected prior to the low noise amplifiers due to phasing adjustment and may be microprocessor controlled to adjust for maximum signal level response. This then allows the use of a low cost combiner. The general arrangement is displayed in FIG. 2. An alternative is displayed in FIG. 3 with that advantage of improved noise figure response. The intelligent control may either be built into the antenna (given receiver feedback) or may be controlled directly from the receiver. These arrangements may be configured for any number of ports above 2 with the benefit of saving PCB real estate and cost for high number of ports or antennas. The antenna array for any of the embodiments described herein can comprise any of the GNSS antenna constructions shown in the patent applications incorporated herein by reference above; Feller et al. U.S. Pat. No. 8,102,325 for GNSS Antenna with Selectable Gain Pattern, Method of Receiving GNSS Signals and Antenna Manufacturing Method; and various other antenna constructions, including patch antennas, crossed-dipole, etc.

### III. Alternative Embodiment with Simplified CW only Controlled Radiation Pattern Antenna (CRPA) for GNSS

The typical method for resolving interference problems in GPS units consists usually of either a) an adaptive filter to remove an in-band jammer or b) a Controlled Radiation Pattern Antenna (CRPA). The adaptive filter is limited to the extent that if the signal is not narrowband (CW) or if it is of sufficient strength it will overload the analog sections of the GNSS receiver.

CRPAs overcome the overload problem by consisting of a number of antennas (an array) and receivers (usually fewer than four) whose outputs are monitored by a controller which adjusts phase shifters and/or attenuators to control the effective radiation pattern of the array in such a fashion as to null out the interferer. These are typically used in high cost applications where the purchase of multiple antennas and receivers can be justified (often military applications).

This application consists of a simplified arrangement for a CRPA which does not require multiple receivers, and which may be self-contained in a single antenna enclosure, however does contain an adaptive control algorithm that functions for CW jamming.

By producing a solution only for CW jamming, it simplifies detection of the jammer by allowing the use of a log detector instead of multiple receivers. It therefore allows the use of a number of low cost antennas to be housed in a single enclosure. FIG. 4 shows the general arrangement:

Simplified detection may be applied either to each antenna channel individually and/or to the combined channel as shown in FIG. 4. Selection of arrangement will be dependent on the exact algorithm chosen. In addition nulling may often be achieved by phase only minimization rather than phase+attenuation minimization. This may then reduce costs further.

### IV. Enhanced Low Cost Ceramic Phased Array Antennas for GPS

The typical low cost antenna that has found its way into most consumer applications is the ceramic patch antenna. Almost universal, these antennas have a single feedpoint and beveled corner in order to promote RHCP polarization. In actuality these antennas have severely elliptical polarizations which results in a high susceptibility to LHCP and hence multipath interference.

In this application it is proposed to make use of the reasonable efficiency of these antennas, and to repair the polarization characteristics by configuring them in a circular array and combining them using appropriate combining and phase networks. Multiple elements (preferably more than two) may be used in this configuration. FIG. 5 shows the general arrangement.

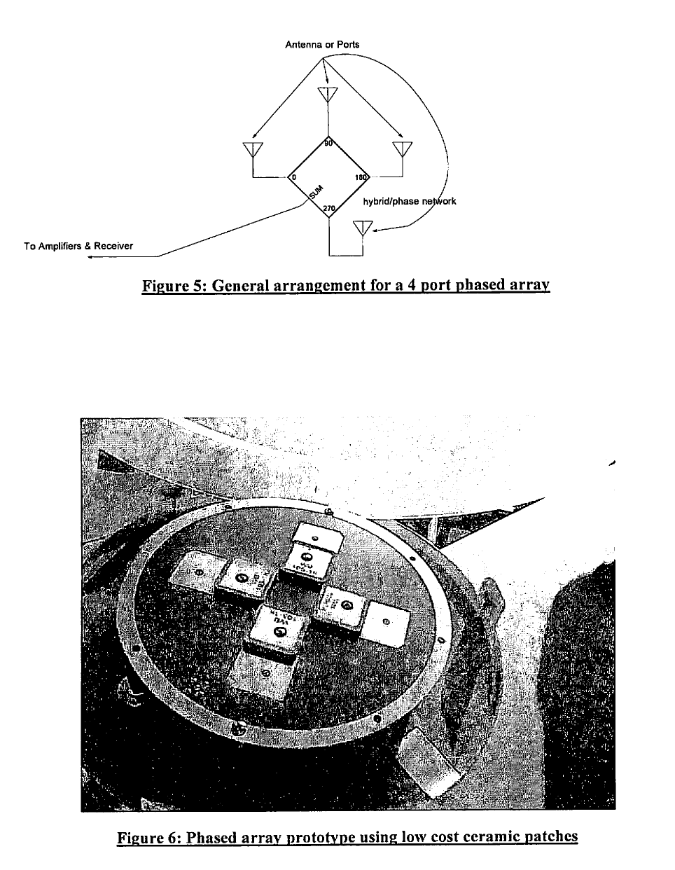

In addition to repairing the RCHP characteristics, additionally it is possible to control the elevation radiation pattern by adjusting the placement of these antenna's (distance from center of array) and by rotation of each one of these elements. Each element type will be uniquely adjusted depending on its elliptical or linear polarization characteristics. FIG. 6 shows the prototype device.

### V. Alternative Embodiment with Antenna Unit Incorporating PTFE Components

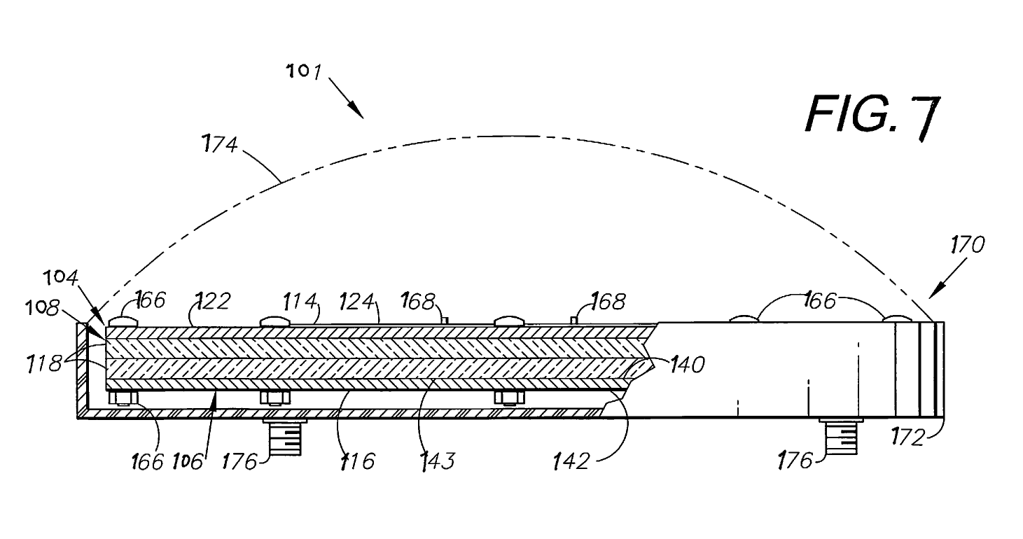

Referring to FIGS. 7-16 in more detail, the reference numeral 101 generally designates an embodiment of an antenna unit incorporating PTFE components according to the present invention. The antenna unit 101 generally includes a radiating element 104, a ground plane element 106 positioned in spaced relation to the radiating element 104, and a dielectric element 108 positioned between the radiating element 104 and the ground plane element 106.

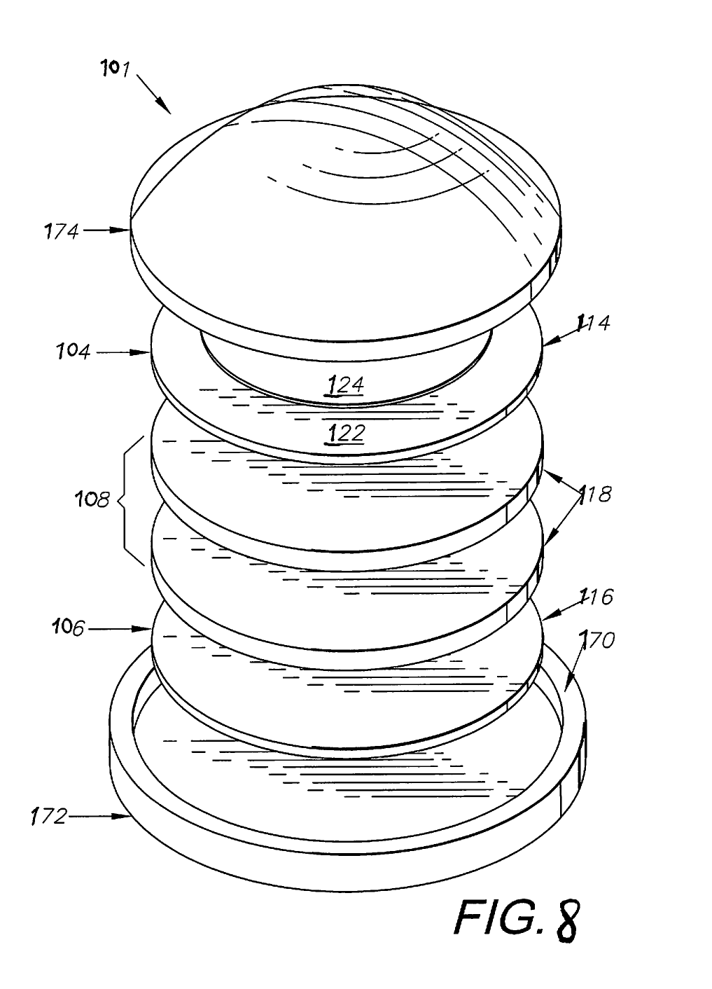

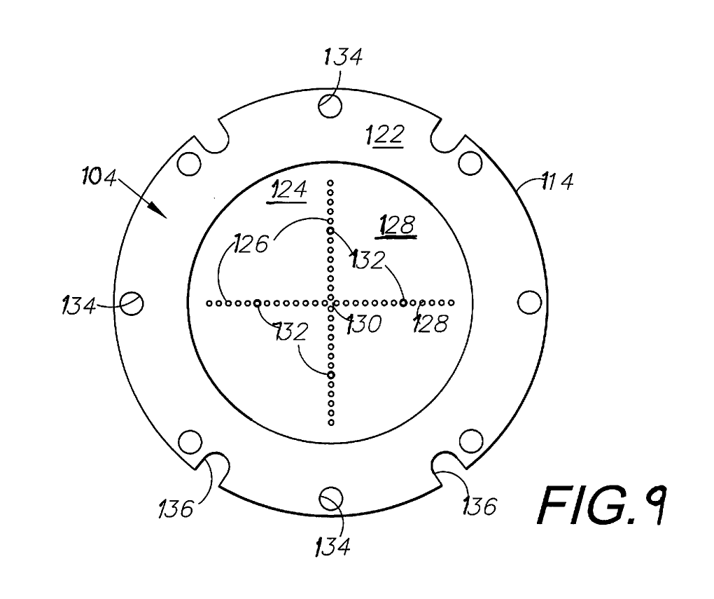

Referring to FIGS. 7 and 8, the illustrated radiating element 104 includes a circular patch antenna board 114, the ground plane element 106 includes a ground plane board 116, and the dielectric element 108 includes a pair of layers 118 of PTFE. Referring to FIGS. 7 and 9, the illustrated patch antenna board 114 is formed by a foil clad FR-4 PC board forming a substrate 122 on which a circular antenna radiator patch 124 remains from a process such as etching. The illustrated patch 124 has arrays or lines 126 of holes 128 drilled therethrough and through the substrate 122. The illustrated lines 126 are straight, equal in length, and radiate from a center 130 of the patch 124 at 90° angular intervals. A middle hole 132 of each line 126 is provided with a soldering pad and may be plated through (not shown). The diameter of the patch 124 provides coarse tuning of the antenna unit 101. The lines 126 of holes 128 form a finer tuning structure for the patch 124 and provide a means of coupling signals gathered by the patch 124 to subsequent circuitry. The substrate 122 has a plurality of assembly holes 134 and notches 136 spaced circumferentially about the periphery thereof. Preferably, the substrate 122 has a minimal thickness to minimize signal losses and may have a thickness on the order of 0.6 mm (24 mil).

Referring to FIGS. 7 and 11, the illustrated ground plane board 116 is formed by a circular foil clad FR-4 PC board having an upper surface 140 and a lower surface 142. As illustrated, the board 116 has ground plane cladding 143 covering most of the upper surface 140, with openings (not shown) etched for a purpose described below. The lower surface 142 has conductors forming or connecting components of a low noise amplifier or LNA circuit 144 and a four port hybrid combiner 146 having terminals 148. The terminals 148 include holes which include solder pads (not shown). The LNA 144 may include a combination of microstrip segments, surface mount components, and discrete components (not shown). Further, the LNA 144 may include one or more antenna line feed connectors 150 for connection of the antenna unit 101 to subsequent circuitry, such as a GNSS receiver (not shown). The ground plane board 116 has an external shape which is similar to the shape of the patch antenna board 114 and is provided with circumferentially spaced assembly holes 152. It is foreseen that the ground plane board 116 may also be provided with assembly notches (not shown) similar to the assembly notches 136 of the patch antenna board 114. As with the patch antenna board 114, the ground plane 116 has a minimal thickness to minimize signal losses and may have a thickness on the order of 0.6 mm (24 mil). It is foreseen that the ground plane board 116 could alternatively be formed with ground plane cladding on the lower surface 142 with openings in the cladding for conductors of the LNA 144 and hybrid 146 isolated from the ground plane cladding.

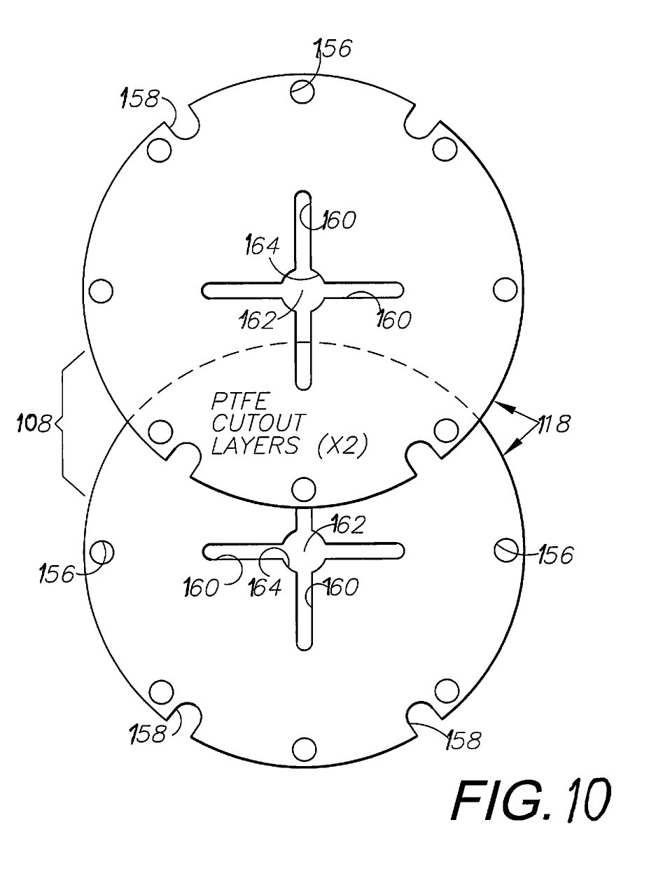

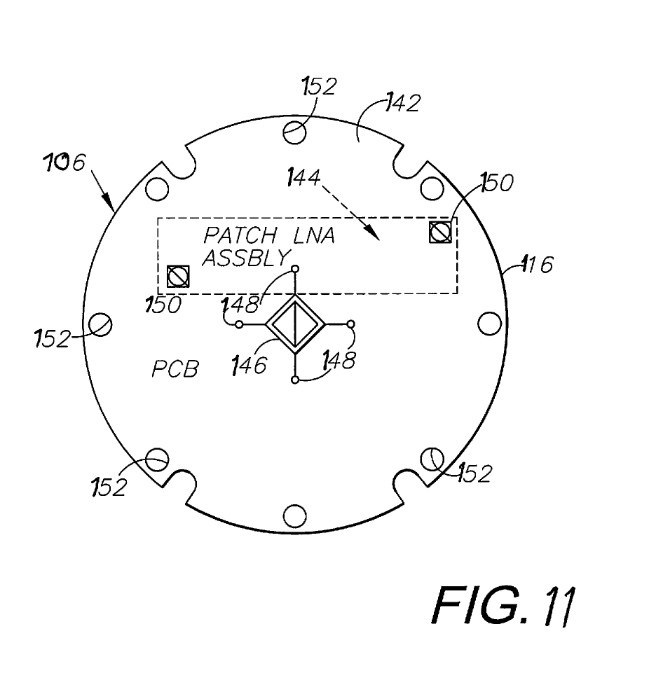

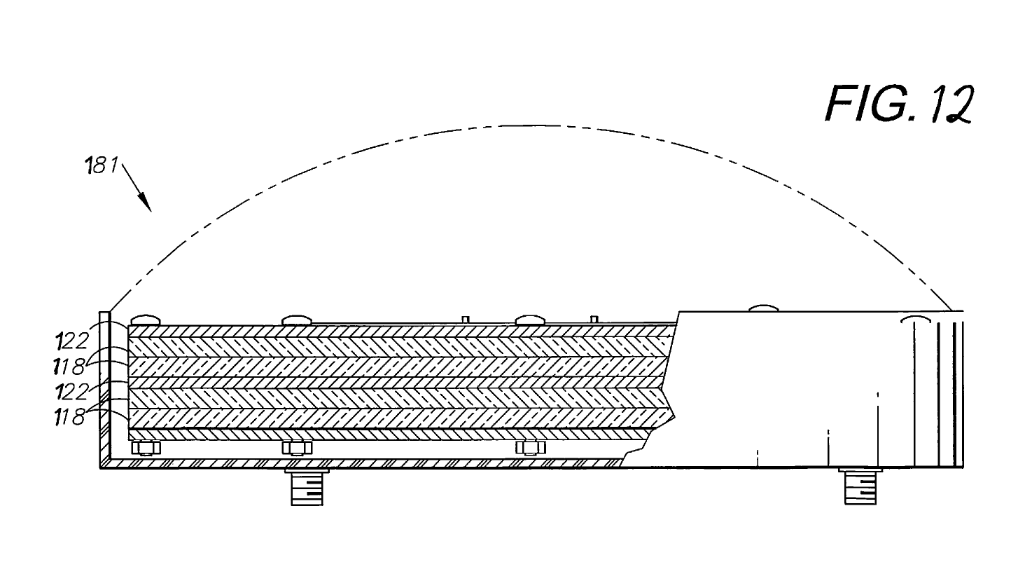

Referring to FIGS. 7 and 10, the illustrated dielectric element 108 is formed by a pair of circular PTFE layers 118. PTFE or polytetrafluoroethelyne is the generic name of a polymer material also known by the proprietary name of Teflon®. The illustrated PTFE layers 118 have an external shape which is similar to the shape of the patch antenna board 114 and include pluralities of circumferentially spaced assembly holes 156 and notches 158. Each of the illustrated PTFE layers 118 has a pair of elongated slots 160 formed therein which intersect at 90° at a center 162 of the layer 118. The center 162 of the layer 118 may be provided with a bore 164 at the intersection of the slots 160. The illustrated PTFE layers 118 have a thickness of 0.125 in (approximately 3.0 mm), although it is foreseen that other thicknesses may be appropriate for a given application. It is also foreseen that a single PTFE layer 118 of an appropriate thickness could be employed. Moreover, additional PTFE layers 118 may be utilized, as shown in the alternative embodiment antenna unit shown in FIG. 12 and described below.

The antenna unit 101 is formed by sandwiching the PTFE layers 118 between the patch antenna board 114 and the ground plane board 116. The slots 160 in the PTFE layers 118 are aligned with the lines 126 of holes 128 in the patch antenna board 114. Additionally, the middle holes 132 of the lines 126 are aligned with the terminals 148 of the hybrid 146 on the ground plane board 116. The assembly holes 134, 156, and 152 are aligned, as are the assembly notches 136 and 158. The boards 114 and 116 and the PTFE layers 118 are held together by sets of fasteners 166, such as nylon screws and nuts. In the illustrated antenna unit 101, signal feeds 168 (FIG. 7) from the antenna patch 124 are provided by conductors soldered between middle holes 132 and hybrid terminals 148 through the slots 160 of the PTFE layers 118. The signal feeds 168 may be in the form of tinned copper wires.

The illustrated antenna unit 101 is mounted in a weatherproof enclosure 170 (FIGS. 7 and 8) formed by an enclosure base 172 and a cover or radome 174. The enclosure 170 may be provided with one or more external antenna line feeds 176 coupled to the LNA antenna feeds 150 and providing for connection of the LNA circuitry 144 with subsequent signal processing circuitry (not shown). The enclosure 170 may also be provided with mounting hardware (not shown) for mounting the antenna unit 101 on a vehicle (not shown).

FIG. 12 shows an antenna unit 181 comprising a modified embodiment or alternative aspect of the present invention. The antenna unit 181 includes four PTFE layers 118, which can be used for increasing the spacing between the radiating element 104 and the ground plane board 116 for optimizing the performance of the antenna unit 181. Otherwise the antenna unit 181 can be constructed similar to the primary embodiment antenna unit 101. Functionally the antenna units 101 and 181 have similar operating characteristics.

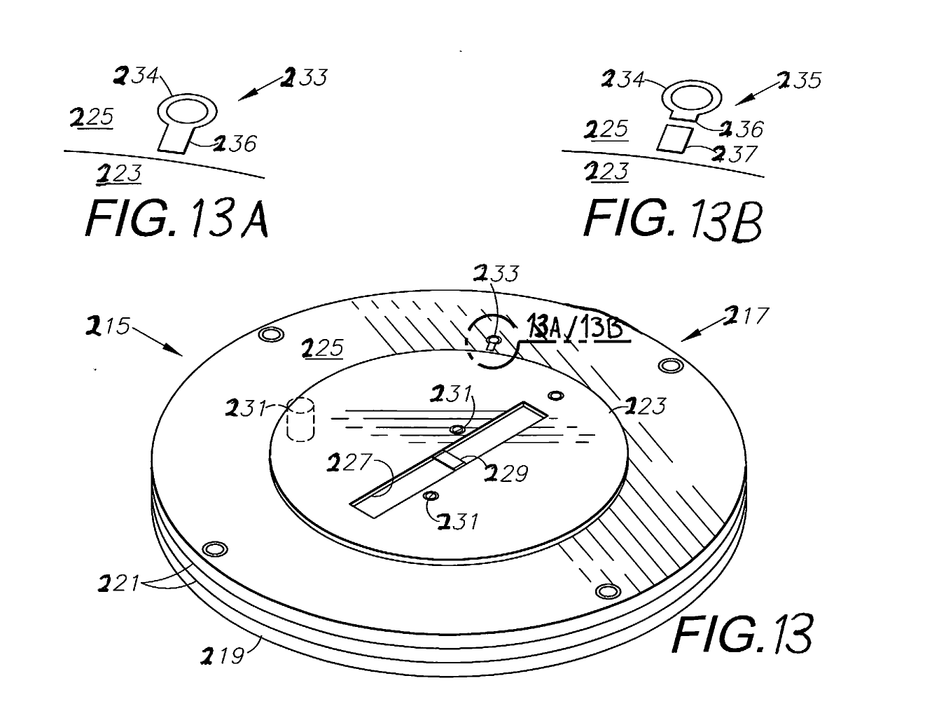

Features of the antenna units 101 and 181 can be applied to antenna configurations employing radiating elements other than the patch antenna board 114. FIGS. 13-16 illustrate additional exemplary embodiments and alternative aspects of the antenna unit 101 employing representative types of radiating elements in combination with ground plane elements and intervening dielectric layers formed of PTFE materials.

FIG. 13 illustrates a dual frequency or dual band patch antenna unit 215 of the present invention employing a patch radiating element 217 positioned in spaced relation to a ground plane element 219 with an intervening dielectric element 221 formed of a PTFE material. The illustrated radiating element 217 is formed from an FR-4 type PC board material with a circular foil antenna patch 223 formed by etching a foil clad substrate 225. The antenna patch 223 includes an elongated slot 227 formed by etching or, alternatively, by a machining operation. The illustrated slot 227 is rectangular and is centered on a diameter of the circular patch 223. The slot 227 may include a reactive element 229, such as a capacitor, which bridges the side edges of the slot 227 to tune the antenna patch 223 to a particular frequency or range of frequencies of interest. In the illustrated dual frequency antenna unit 215, the patch 223 can, for example, be tuned to the L2 frequency (1227.60 MHz) while the slot 227 is tuned to the L1 frequency (1575.42 MHz). The antenna unit 215 may include a feed structure (not shown) to couple a signal from the antenna patch 223 to LNA circuitry (not shown) on the ground plane element 219. One or more antenna feed line connectors 231 may connect to the LNA circuitry 144 to output a signal to subsequent processing circuitry (not shown). The antenna unit 215 may be housed in an enclosure (not shown) somewhat similar to the enclosure 170.

FIG. 13A is an enlarged detail of the antenna unit embodiment shown in FIG. 13 with a single-capacitor patch tuning point 233 with a shunt-to-ground conductor 234 and a conductor extension 236 providing capacitance with the patch 223.

FIG. 13B is an enlarged detail of the antenna unit embodiment shown in FIG. 13 with a double-capacitor patch tuning point 235 with a shunt-to-ground conductor 234 and a conductor extension 236. An intermediate conductor 237 provides additional capacitance in series with the patch 223 and the conductor extension 236. It will be appreciated that one or both of the patch 223 and the slot 227 can be tuned independently. The slotted-patch antenna unit 215 can be provided with any combination of slot-tuning (e.g., with the capacitor 229) and/or patch-tuning (e.g., with the shunt-to-ground tuning points 233 and 235). Alternatively, the antenna unit 215 can be constructed and operated with other tuning components, or without tuning components.

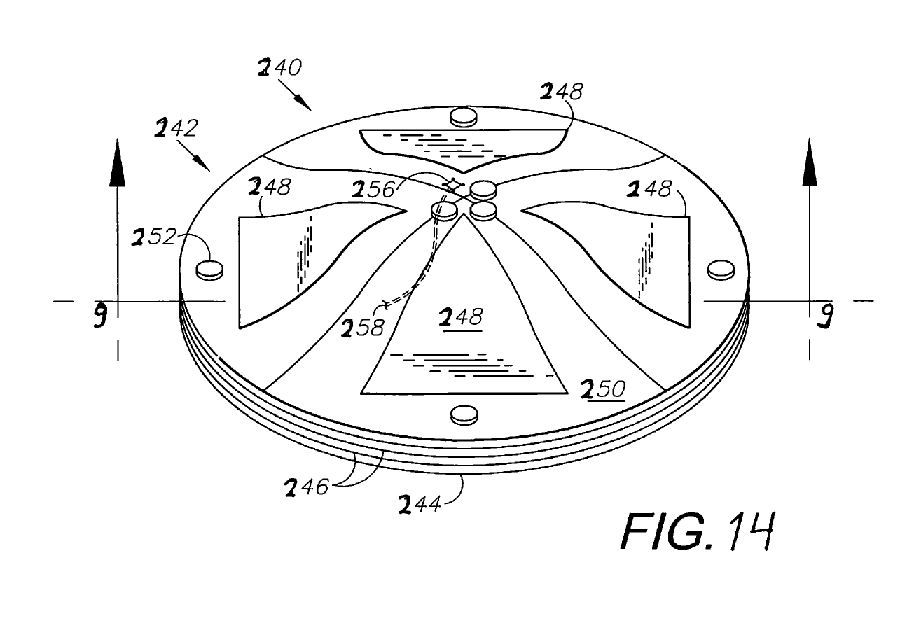

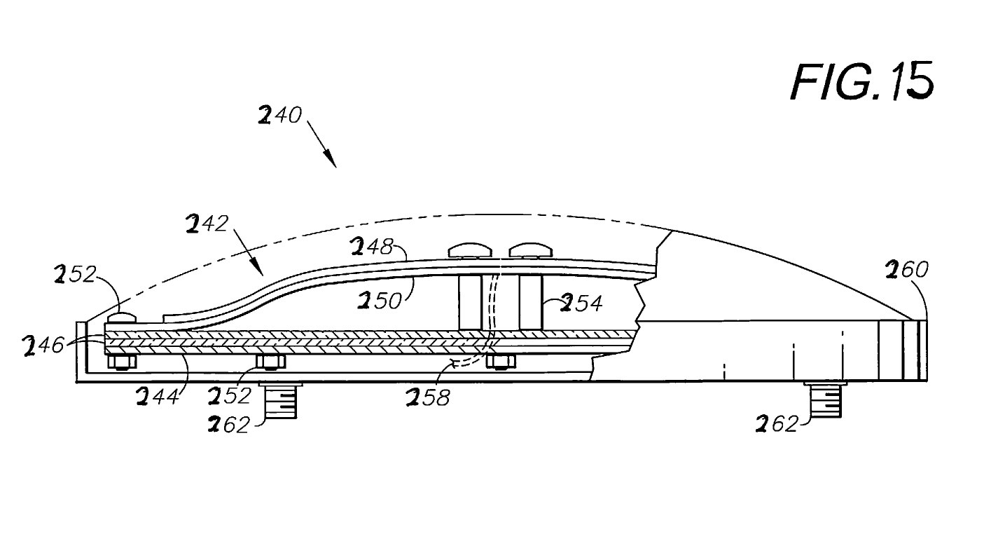

FIGS. 14 and 15 illustrate a low profile crossed dipole antenna unit 240 according to the present invention. The antenna unit 240 includes a radiating element 242 positioned in spaced relation to a ground plane element 244 with an intervening dielectric element 246 formed of a PTFE material. The illustrated radiating element 242 is of a molded PC board configuration with dipole elements 248 formed on a substrate 250 of a clad PC board material. The shape of the dipole elements 248 determines the beam pattern of the antenna unit 240 to balance an effective angle of use of the unit 240 with rejection of multipath signals. The radiating element 242 may be of a relatively rigid nature or may, alternatively, be flexible. The radiating element 242 is secured to the dielectric element 246 and the ground plane element 244 by fasteners 252, such as sets of nylon screws and nuts. The shape of the radiating element 242 may be maintained by dielectric spacer posts 254 positioned between the substrate 250 and the dielectric element 246. The illustrated antenna unit 240 may include hybrid combiner circuitry 256 which is coupled to the dipole elements 248 and which feeds signals therefrom to LNA circuitry (not shown) positioned on a lower side of the ground plane element 244 by way of a transmission line 258 such as a short length of coaxial cable. The low profile crossed dipole antenna unit 240 may be housed in a weatherproof enclosure 260 similar to the enclosure 170. External antenna line feeds 262 can be provided on the bottom of the enclosure 260.

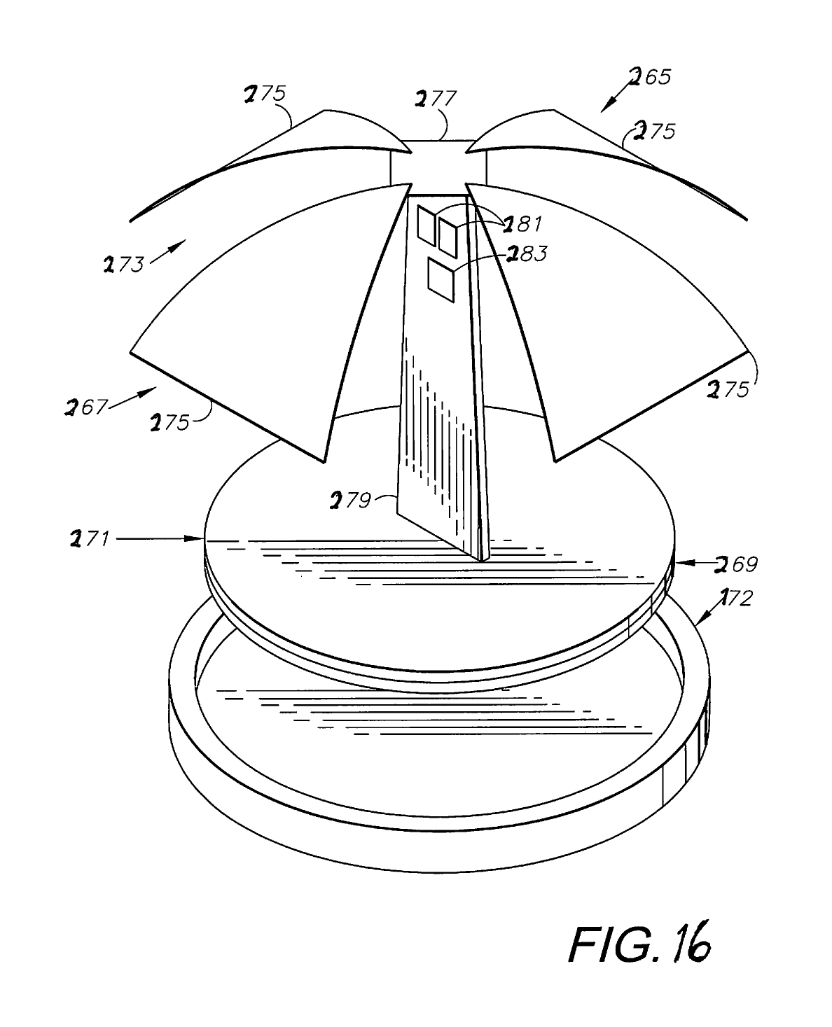

FIG. 16 illustrates a vertically extended crossed dipole antenna unit 265 including a crossed dipole radiating element 267, a ground plane element 269, and a dielectric element 271 formed of a PTFE material. The radiating element 267 is in the form of a crossed dipole radiating arm assembly 273 including pairs of opposing dipole arms 275 secured to a hub 277. The arm assembly 273 is supported in spaced relation to the ground plane element 269 and the dielectric element 271 by a vertical support 279 formed by a PC board. The vertical support 279 may include matching circuitry 281 and LNA circuitry 283. The beam pattern of the antenna unit 265 can be controlled by the droop of the dipole arms 275, with a deeper droop increasing the angular response of the antenna unit 265 and a shallower droop decreasing the angle of response and additionally decreasing the response of the unit 265 to multipath interference. Additional features of crossed dipole type antennas can be found in commonly assigned U.S. Pat. No. 8,102,325, which is incorporated herein by reference. The antenna unit 265 can be housed in an enclosure (not shown) similar in some respects to the enclosure 170.

### VI. Alternative Embodiment with Crossed Loop Antenna System

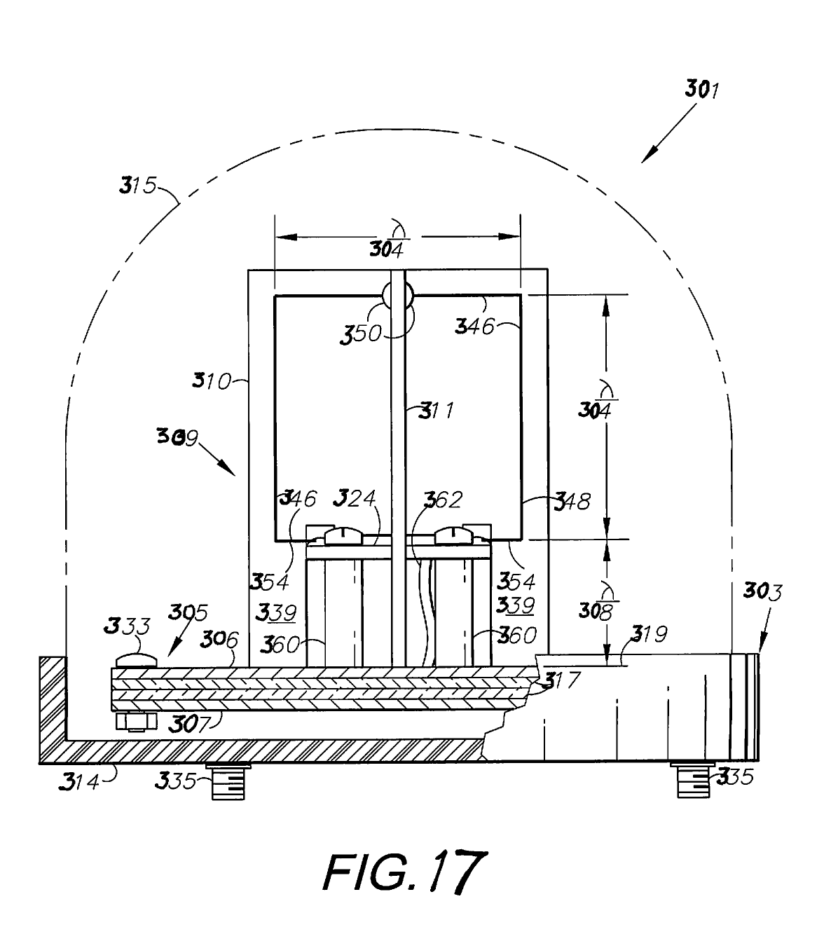

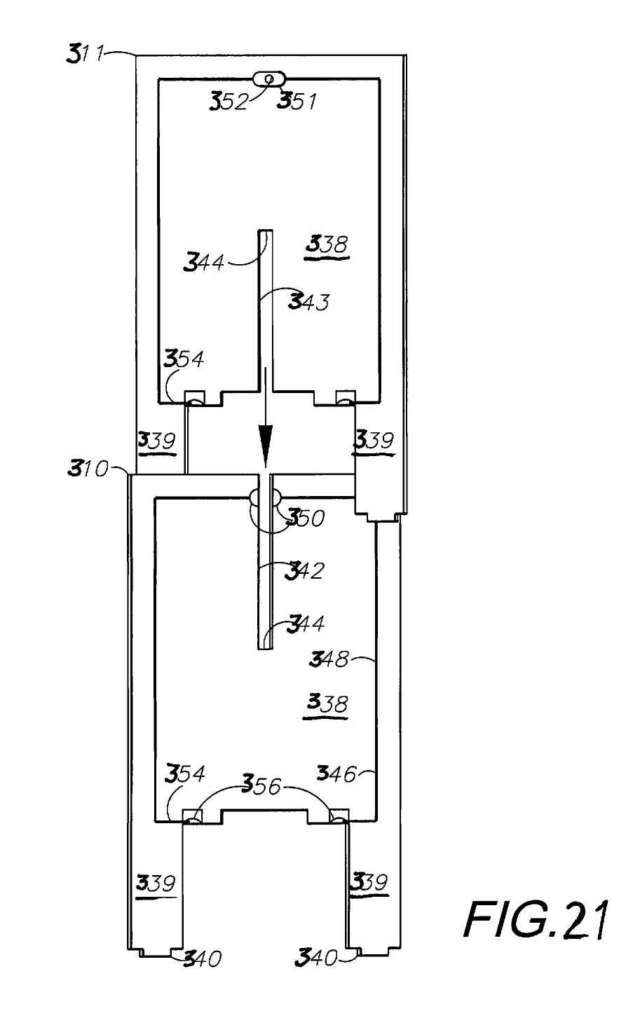

Referring to FIGS. 17-21 in more detail, the reference numeral 301 generally designates an embodiment of a crossed loop antenna system incorporating PTFE components according to the present invention. The illustrated antenna system 301 generally includes an enclosure assembly 303, a ground plane assembly 305 including a ground plane board 306 and an LNA board 307, and a radiating assembly 309 including a pair of loop antenna boards 310 and 311 joined in a 90° relationship. The enclosure assembly 303 generally includes an enclosure base 314 and a radiotransparent weather cover or radome 315 sealingly joined with the base 314. The ground plane assembly 305 is supported on the enclosure base 314 and has the radiating assembly 309 secured thereto in an upright relation.

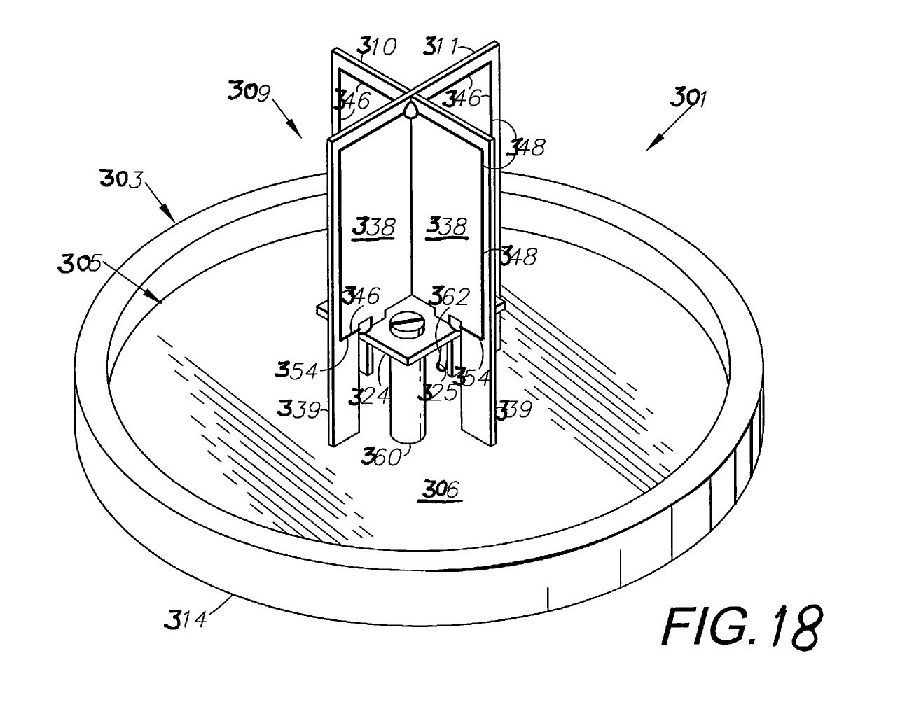

Referring to FIGS. 17 and 18, the illustrated ground plane assembly 305 includes the ground plane board 306 and the LNA board 307 which are separated by one or more dielectric boards 317. The boards 317 can be formed of PTFE or other materials, such as an FR-304 composite. The ground plane board 306 has a foil cladding 319, such as a copper foil cladding, on most of its top surface which forms an electrical ground plane for the system 301. The foil cladding 319 may be coated with a material such as a lacquer 320 or the like to seal the cladding 319 from corrosion. The illustrated ground plane board 306 is provided with aligned sets of slots 321 in a 90° pattern which are sized and spaced to receive ends of the loop boards 310 and 311, as will be described further. The board 306 may be provided with bores 322 for supporting a combiner board 324 (FIGS. 17 and 18), as will be described further. A feed bore 325 may be provided, as will be described further. Finally, a plurality of assembly holes 326 are provided in circumferentially spaced relation about the periphery of the ground plane board 306.

The illustrated LNA board 307 has components (not detailed) of a low noise amplifier or LNA circuit or assembly 328 on a bottom surface 329 thereof. The LNA circuitry 328 may be formed of a combination of surface mount components and microstrip elements (not shown). The LNA circuitry 328 may include one or more feed connectors 330 which provide for connection of the LNA circuitry 328 to further processing stages of a GNSS receiver or the like (not shown). The LNA board 307 is provided with a plurality of circumferentially spaced assembly holes 331 about its periphery which may be aligned with the assembly holes 326 of the ground plane board 306 and with similar holes (not shown) formed in the dielectric boards 317. The ground plane board 306, the dielectric boards 317, and the LNA board 307 may have their assembly holes 326 and 331 aligned to receive fasteners 333 (FIG. 17) to assemble the ground plane assembly 305. The fasteners 333 may be sets of nylon screws and nuts or the like. The enclosure base 314 may have one or more external feed connectors 335 (FIG. 17) which connect with the feed connectors 330 of the LNA board 307 to connect the LNA circuitry 328 with further stages.

Referring to FIGS. 17, 21, and 6, the radiating assembly 309 includes the loop antenna boards 310 and 311. Each of the boards 310 and 311 includes a rectangular upper section 338 with a pair of support legs 339 extending from a lower end thereof. Each of the illustrated legs 339 has a mounting tab 340 at a lower end which is sized to be received in one of the slots 321 of the ground plane board 306. The tabs 340 may be secured in the slots 321 by gluing, welding, or soldering of solder pads (not shown) on the tabs 340 and near the slots 321. One of the boards, such as board 310, is a top slotted board, having a top opening slot 342. The other board, such as board 311, is a bottom slotted board, having a bottom opening slot 343. When the boards 310 and 311 are assembled, the slots 342 and 343 are aligned and the boards are slid until ends 344 of the slots meet. The boards 310 and 311 are secured together in a 90° relation with the slot ends 344 meeting by gluing, welding, or the like.

Each of the illustrated loop antenna boards 310 and 311 is formed of a foil cladded substrate of polytetrafluoroethelyne or PTFE material. The copper foil cladding is etched to leave conductors 346 forming a square loop 348. Each of the illustrated loops 348 is a full wave loop at the frequency of operation of the antenna system 301. Thus, each side of the loops 348 is a quarter wavelength long, as shown in FIG. 17. In the illustrated antenna system 301, the loop conductors 346 are formed on only one side of each board 310 and 311. It is foreseen that each of the boards 310 and 311 could be formed as a dual layer laminated board (not shown) with the loop conductors 346 formed on one of the surfaces within such a laminated board.

On the top slotted loop antenna board, illustrated as board 310, the slot 342 requires a gap in the upper loop conductor 346. In order to complete the circuit of the loop 348 on the board 310, a pair of gap solder pads 350 is provided. The bottom slotted board 311 is provided with somewhat elongated solder pads 351 at a center of the top loop conductor 346. The solder pads 348 on opposite sides of the board 311 are interconnected, as by a plated through hole 352. When the boards 310 and 311 are joined, the gap solder pads 350 of the board 310 are soldered to the elongated solder pads 351 to complete the circuit of the loop 348 on the top slotted board 310. This also interconnects the loops 348 of the boards 310 and 311. However, the center of the top conductor 346 of the loops 348 is at a voltage null. This is a typical interconnection of crossed loop antennas. Each of the loops 348 has a set of feed conductors 354 which terminate in feed solder pads 356.

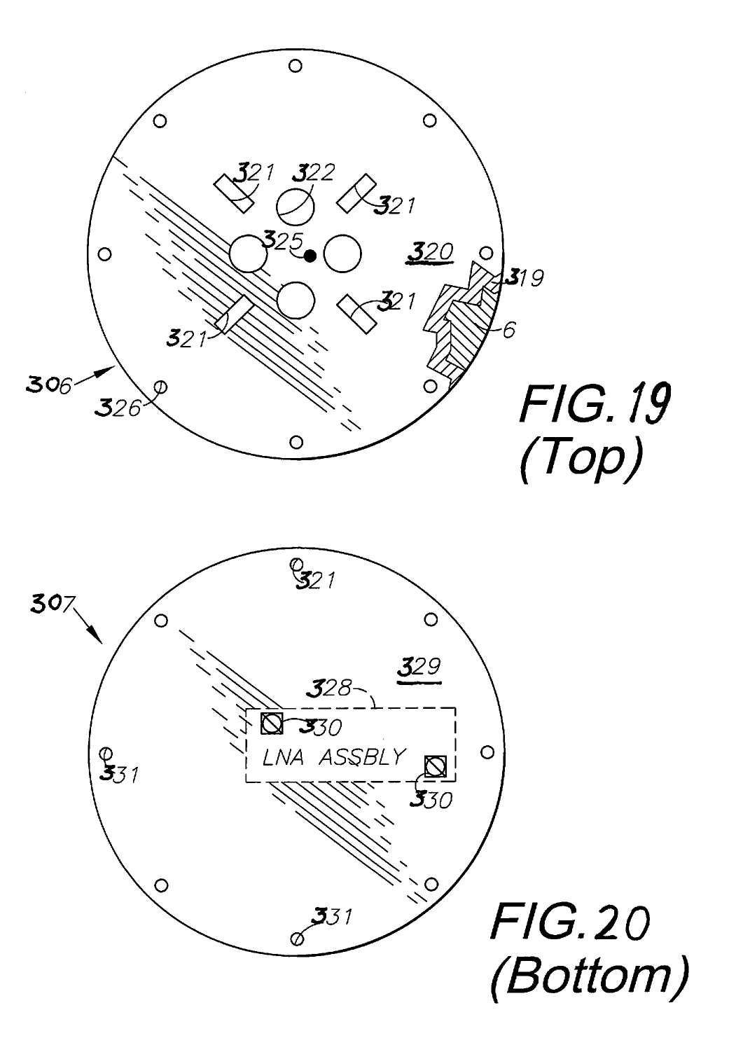

When the antenna loop boards 310 and 311 are joined, the feed conductors 354 are coupled to conductors of combiner or hybrid circuitry (not shown) on the combiner board 324. The feed solder pads 356 are soldered to combiner solder pads (not shown) to couple the antenna loops 348 with the combiner circuitry. The combiner board 324 is supported by combiner support posts 360 which join with the bores 322 provided on the ground plane board 306. The illustrated loop board legs 339 and posts 360 have lengths to position the lower conductors 346 of the antenna loops 348 at a quarter wavelength from the ground plane conductor 319 of the ground plane board 306 at the frequency of operation of the antenna system 301, as shown in FIG. 17. The combiner circuitry may be coupled to the LNA circuitry 328 by means of a short length of coaxial cable 362 which extends from the combiner board 324, through the feed bore 325 (FIG. 19) of the ground plane board 306 and through the dielectric layers 317, if present, to the LNA circuitry 328 on the LNA board 307.

### VII. Alternative Embodiment Multipath Cancelling Antenna

What is proposed is a multipath cancelling antenna which will subtract any left hand circular portion of signals from tracking in a GNSS receiver. This can be accomplished with an antenna which has both left hand circular polarization (LHCP) and right hand circular polarization (RHCP) ports available. This is common as many antennas use quadrature hybrids to generate the phasing and normally the LHCP port is simply terminated. What is proposed is to use the signals received from the LHCP port to determine which satellites have very high multipath and remove them from the solution. Use a GNSS receiver to track satellites on the LHCP port of the antenna. Any satellites whose CNo is within 10 dB of the RHCP receiver CNo, should be removed from the navigation calculation of the main receiver using the RHCP signal path. This can be accomplished using an inexpensive GPS module to simply determine the signal strength and PRN of satellites with poor polarization.

A further alternative is to make a perfect RHCp antenna across both bands by using the LHCP port of the hybrid and phasing it and recombining it to cancel on the RHCP side. This is required because due to tolerances and repeatability antennas usually end up with +/−2 dB of axial ratio not the perfect 0 dB. Axial ratio is the major to minor axis ratio for an ellipse defined by the polarization. A perfect circle has equal axis and so the ratio is 1 or 0 dB. A further issue is GNSS signals occupy two major bands 1.165 to 1.26 GHz and 1.54 to 1.61 GHz. It is possible to make perfect polarization at one band or the other but to achieve this on both is very difficult. This technique of recombining a sample of the LHCP out of phase can be achieved separately on each band. A test setup with a linear polarized transmit signal is required with a tuning Voltage adjusted on the phase shifter until both the horizontal and vertical orientations have the exact same level.

Another implementation to achieve the cancellation of reflections is to use a second antenna which does not see the upper hemisphere of the gain pattern, but is downward looking. The GNSS antennas are upward pointing to receive the satellites signals. Using a downward pointing antenna will only receive reflections which need to be cancelled. These can either be removed from the solution or cancelled using a phase shifter and tracking algorithm.

### VIII. Conclusion

It is to be understood that while certain forms of the present invention have been illustrated and described herein, it is not to be limited to the specific forms or arrangement of parts described and shown.

Having thus described the invention, what is claimed as new and desired to be secured by Letters Patent is:

1. An antenna structure comprising:
(a) an antenna element;
(b) a ground plane element positioned in spaced relation to said antenna element; and
(c) a dielectric layer formed by a PTFE material and positioned between said antenna element and said ground plane element.

2. A crossed loop antenna system comprising:
a crossed loop radiating assembly formed by a pair of loop antenna boards joined in a substantially perpendicular relationship;
each loop antenna board being formed by etching a foil cladded substrate formed of a polytetrafluoroethylene (PTFE) material;
the ground plane positioned in spaced relation to said crossed loop radiating assembly; and
low noise amplifier (LNA) circuitry coupled to said crossed loop radiating assembly.

3. A crossed loop antenna configuration with a PTFE component, substantially as described and illustrated herein.
